(19) United States
(12) Patent Application Publication
(10) Pub. No.: US 2004/0247965 A1
(43) Pub. Date: Dec. 9, 2004

(54) Maintaining PEM fuel cell performance with sub-freezing boot strap starts

(76) Inventors: Gennady Resnick, South Windsor, CT (US); Carl A. Reiser, Stonington, CT (US); Neil A. Popovich, Ellington, CT (US); Jung S. Yi, Mansfield, CT (US)

Correspondence Address: M. P. Williams, 210 Main Street, Manchester, CT, 06040, US

(21) Appl. No.: 10/456,412

(22) Filed: Jun. 6, 2003

(51) Int. Cl. H01M 8/04

(52) U.S. Cl. 429/26

(57) ABSTRACT

The fuel cells (16, 18) adjacent or near the end plate (15) of a fuel cell stack (14) are warmed either by (a) a heater wire (48) within the fuel cell (16) adjacent to the end plate, (b) heater wires (53) are disposed in a heater element (52) located between the end plate and the fuel cell closest to the end plate (15), (c) one or more heaters (56) are disposed in holes (55) within the end plate (15), (d) electric heating elements (59) on a surface of the end plate (15), or (e) a catalytic heater (61) disposed on the surface of the end plate. The fuel cells (16, 18) may be heated before or during operation at sub-freezing temperatures to prevent loss of fuel cell performance, or may be heated after operation at sub-freezing temperatures to restore fuel cell performance.

### TECHNICAL FIELD

This invention relates to utilizing heat at or near the end cell and/or adjacent pressure plate (also known as end plate or current collector) in PEM fuel cells which are started at sub-freezing temperatures, to avoid cells with degraded performance and/or to restore cell performance.

### BACKGROUND ART

When proton exchange membrane (PEM) fuel cells are started at sub-freezing temperatures, either directly with the intended load, such as electric vehicle powered by such cell, or by means of an auxiliary load, or both, the cells adjacent to the end plates (current collectors, or pressure plates) exhibit unacceptably poor performance, which is especially pronounced in the cells close to the cathode end of the cell stack assembly.

Over a period of time, the cells located at the anode end of the cell stack recover just by running the fuel cell. But performance at the cathode end of the cell stack assembly improves only slightly and never recovers completely by itself. Although it has been shown that the performance loss was caused by cathode flooding which may be mitigated or even cured completely by dry-out or by hydrogen pump, both of these procedures are too complicated for satisfactory use by users, particularly with respect to a fuel cell powering an electric vehicle.

In the prior art, the problem was different since all of the individual cells were brought up to proper operating temperature before startup, by circulation of preheated coolant through the stack. Such a system is illustrated in U.S. Pat. No. 5,132,174. In a fuel cell powering a vehicle at sub-freezing temperatures, the coolant would first have to be brought up to temperature, after which the coolant would have to circulate through the fuel cell for a time before each of the cells would be up to normal operating temperature. In a fuel cell operating a vehicle at sub-freezing temperatures, the delay of 15 minutes (or more) to achieve cell operating temperature would be intolerable.

### DISCLOSURE OF INVENTION

This invention is predicated on our discovery that poor end-cell performance in a fuel cell stack assembly following boot strap startup at sub-freezing temperatures is due to the end plates, which typically comprise a very large heat sink, and cool the end cells to temperatures below the water freezing point, which is unacceptable unless some form of performance recovery is implemented. The invention is predicated in part on our discovery that heating of the end cells at the cathode end of the cell stack assembly can mitigate or eliminate the performance loss. The invention is also predicated in part on our discovery that heating of the end cells or of the adjacent end plate can avoid loss of performance resulting from boot strap startup at sub-freezing temperatures.

According to the present invention, heat is provided in the vicinity of end cells, at least at the cathode end of a cell stack assembly, either before or during a boot strap startup at sub-freezing temperatures to mitigate loss of performance, or following a boot strap startup so as to provide a performance recovery, or both.

In accordance with the invention, the heat may be applied directly within the fuel cell, between the fuel cell and the end plate, directly within the end plate, or on the surface of the end plate, either by means of electric heat or fuel combustion, such as a catalytic heater.

The invention may be utilized with solid end plates, or with hybrid end plates having a structural, rigidizing portion composed of a composite material, such as fiberglass impregnated with resin, and a much smaller current collection plate disposed between the composite material and the last cell of the stack.

The invention does not rely on preheated, non-freezable coolant, as is the case in prior art fuel cells.

According to the invention, when effecting a boot strap startup at sub-freezing temperatures, providing heat near the end cells of the cell stack assembly sufficient to warm the end cells above the freezing temperature of water, there is no performance loss. In case a performance loss occurs due to inadequate heating during startup, a recovery process, according to the invention, comprises heating the end cells to a temperature higher than the average temperature of the fuel cell stack assembly by between 2° C. (36° F.), and 20° C. (68° F.), and preferably by between 5° C. (41° F.) and 10° C. (50° F.) for between four hours and five hours. Thus, the invention may be used to mitigate or eliminate performance loss in the first instance, or to recover performance, as a consequence of boot strap startup at sub-freezing temperatures.

Other objects, features and advantages of the present invention will become more apparent in the light of the following detailed description of exemplary embodiments thereof, as illustrated in the accompanying drawing.

### BRIEF DESCRIPTION OF THE DRAWINGS

FIGS. 1-6 are stylized, simplified side elevation sectional views, with sectioning lines omitted for clarity, of one and a fraction fuel cells adjacent to the end plate at the cathode end of a fuel cell stack, as follows:

FIG. 1, with heating element in the last fuel cell;

FIG. 2, with a heater element disposed between the last cell and the end plate;

FIG. 3, with a heating element inside the end plate, near the last cell;

FIG. 4, with an electrical surface heater on the end surface of the end plate;

FIG. 5, with a catalytic burner on the end surface of the end plate; and

FIG. 6, with a heater element in the last cell adjacent to an end plate which comprises a small collector plate and a composite rigidizing portion.

### MODE(S) FOR CARRYING OUT THE INVENTION

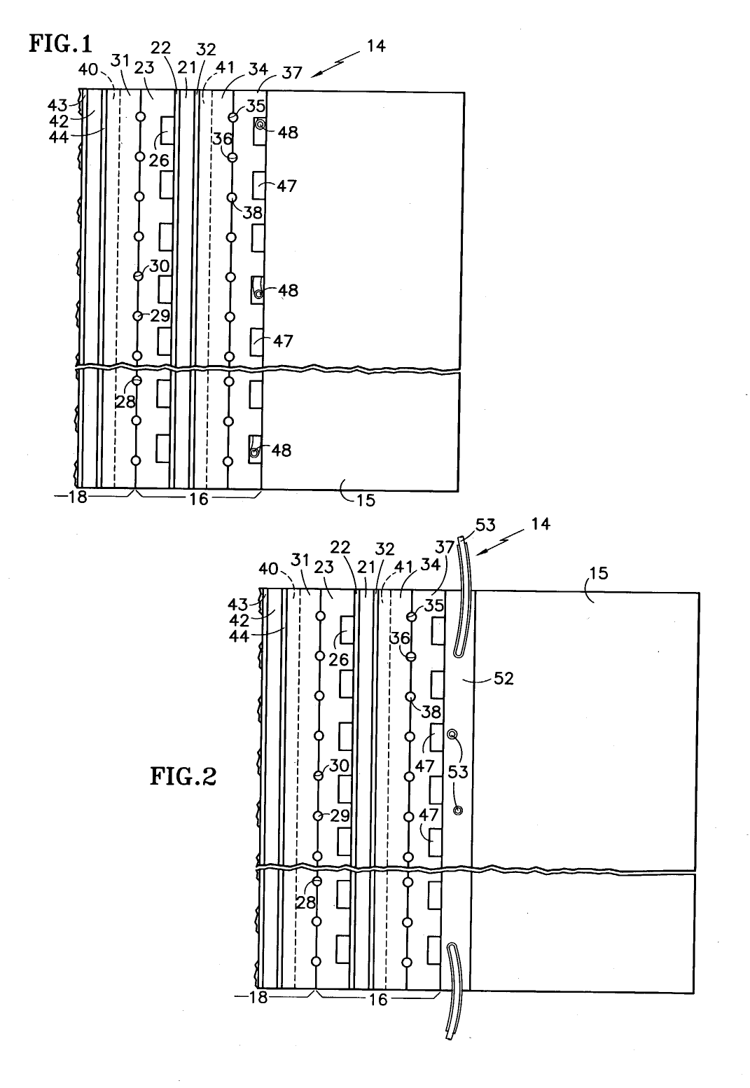

In FIG. 1, a fuel cell stack 14 has an end plate 15 and cells, only the end fuel cell 16 and a portion of the next-to-end fuel cell 18 are shown. The end fuel cell comprises a membrane electrode assembly 21 which includes a proton exchange membrane together with cathode and anode catalysts. An anode support plate 22 is adjacent to an anode water transport plate 23, which is porous and includes fuel flow field passages 26 and grooves 28 which make up coolant water passageways 29 when matched with grooves 30 on an adjacent cathode water transport plate 31. Similarly, a cathode support plate 32 is adjacent to a cathode water transport plate 34 which is porous and has grooves 35 which, when matched with grooves 36 of an additional anode water transport plate 37 will form water passages 38. The cathode water transport plate 31 of the cell 18 has oxidant reactant gas passages 40, and the cathode water transport plate 34 has oxidant reactant gas flow field passages 41.

The next-to-end fuel cell 18, only partially shown, includes a membrane electrode assembly 42, an anode support plate 43, and a cathode support plate 44, the remainder of this fuel cell being broken away for simplicity. The additional anode water transport plate 37, which is present simply to complete the water passages 38 for the cathode of the last fuel cell 16 does not have any fuel reactant gas flowing in channels 47. In a first embodiment of the invention, insulated resistance wire 48 may be threaded through some, as shown, or all, of the channels 47, as necessary, to provide sufficient heat so that the end fuel cell 16 will not be below freezing temperatures during a boot strap startup, or to provide sufficient heat so as to cause recovery of the end cell 16, as the case may be.

In a second embodiment of the invention shown in FIG. 2, a heater plate 52 has insulated resistance wire 53 embedded therein and is disposed between the additional water transport plate 37 and the end plate 15. The wire 53 may be in a zig-zag or serpentine path or in any other suitable shape as may be found desirable in any particular utilization of the present invention.

In FIG. 3, the end plate 15 has a plurality of holes 55 drilled therein (only one being shown) and a heater 56 disposed in each of the holes. Preferably, the heater 56 is disposed close to that surface of the end plate 15 which is in contact with the additional water transport plate 37. However, the heaters could be in other positions.

The embodiments of FIGS. 1-3 serve not only to heat the fuel cell itself, either directly or through conduction, but also to provide a temperature gradient which isolates the fuel cell from most or all of the cold mass of the end plate 15.

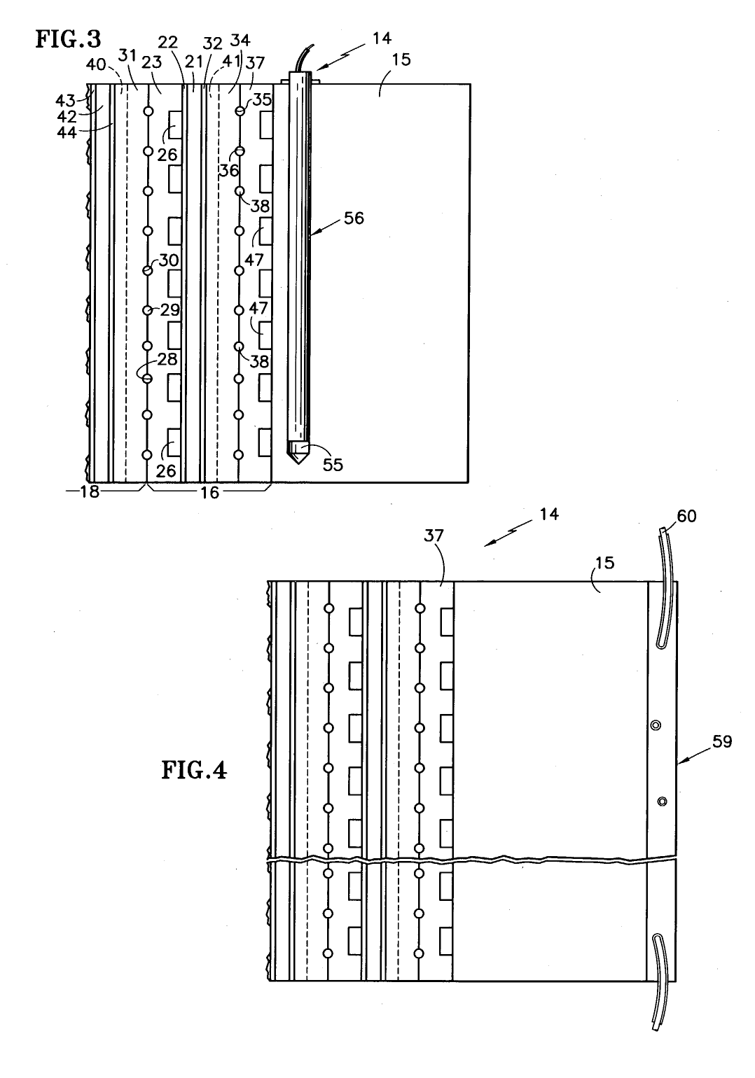

In FIG. 4, an electric heater element 59 having insulated resistance wires 60 embedded therein heats a surface of the end plate 15 which is opposite to that which is in contact with the additional water transport plate 37. While this is less favorable in the sense that it does not provide a heat gradient which is preferential to the fuel cells themselves, it is simpler to install and maintain than the embodiments of FIGS. 1-3.

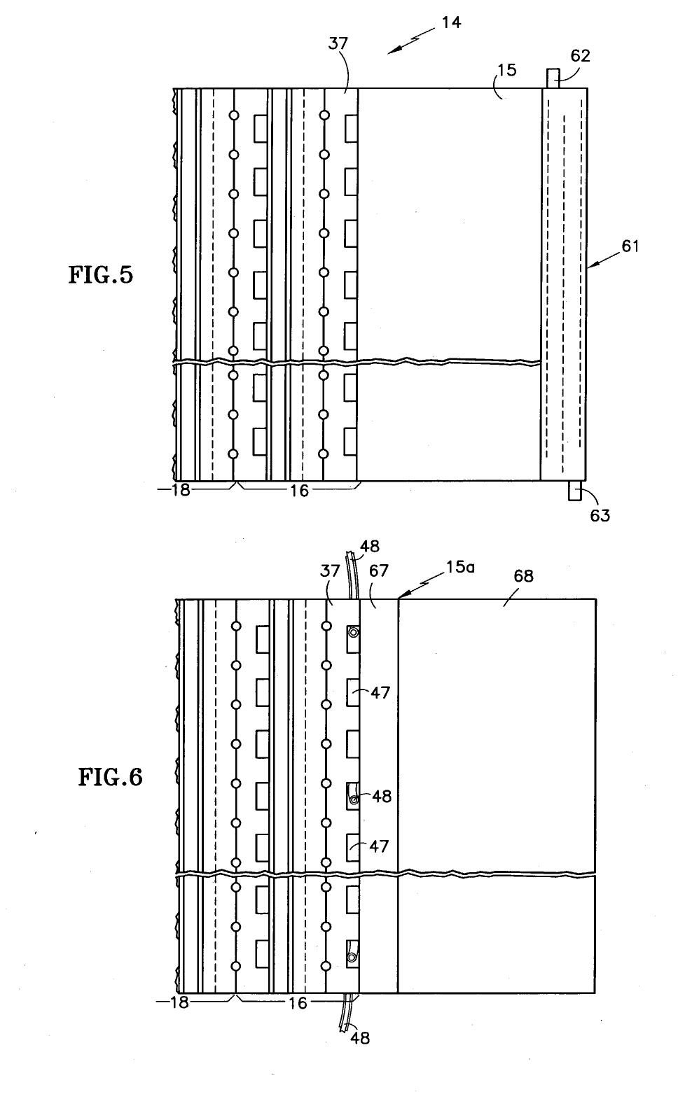

In FIG. 5, a catalytic burner 61 may receive fuel, such as a hydrogen rich gas, through a fuel inlet 62, and oxidant, such as air, through an oxidant inlet 63. Instead of a catalytic burner, any fuel oxidizing heater may be used on the end surface of the end plate 15 which is opposite to the surface in contact with the additional water transport plate 37.

Referring to FIG. 6, an end plate 15a includes a relatively small, conductive current collector 67, and a larger rigidizing portion 68 which may be formed of composite material, such as resin reinforced fiberglass. Such a two-part end plate, having a composite section 68 and a current collector 67 is shown in copending U.S. patent application Ser. No. 10/141,612, filed May 8, 2002. The rigidizing portion 68 provides a rigid flat surface which allows applying the required pressure to the fuel cell stack so as to join all of the cells in one continuous electrical path. The composite rigidizing portion 68 does not operate as a huge heat sink, and therefore contributes little to cooling of the fuel cells 16, 18. FIG. 6 illustrates the embodiment of FIG. 1 being utilized with a two-part end plate 15a; the embodiments of FIGS. 2 and 3 are also equally useful with a two-part end plate 15a.

Thus, the invention comprises warming the fuel cells which are adjacent or near to the end plate by means of either a heater within the end fuel cell (FIG. 1), a heater between the end fuel cell and the end plate (FIG. 2), one or more heaters within the end plate adjacent to the fuel cells (FIG. 3) or heating the surface of the end plate which is opposite to the surface of the end plate which is in contact with the fuel cells (FIGS. 4 and 5). The warming of the fuel cells may be before or during a boot strap startup at sub-freezing temperatures so as to avoid degradation of fuel cell performance, or may take place after a series of boot strap startups at sub-freezing temperatures so as to restore normal performance.

The aforementioned patent and patent application are incorporated herein by reference.

Thus, although the invention has been shown and described with respect to exemplary embodiments thereof, it should be understood by those skilled in the art that the foregoing and various other changes, omissions and additions may be made therein and thereto, without departing from the spirit and scope of the invention.

We claim:

1. A fuel cell power plant comprising:
a stack of fuel cells;
an end plate at either end of said stack of fuel cells; and
means, comprising either (a) an electric resistance heating element or (b) a hydrocarbon fuel combustor, for warming fuel cells adjacent and/or near at least one of said end plates, said means disposed either (b) within a fuel cell that is contiguous with an end plate, (d) between an end plate and a fuel cell closest to the end plate, (e) within an end plate, or (f) on a surface of an end plate.

2. A power plant according to claim 1 wherein:
insulated resistance wire is disposed within at least some unused reactant gas channels of said contiguous fuel cell.

3. A power plant according to claim 1 wherein:
an electrically powered heater plate is disposed between an end plate and a fuel cell contiguous with said end plate.

4. A power plant according to claim 1 wherein:
at least one heater element is disposed in a hole provided in said end plate.

5. A power plant according to claim 4 wherein:
each heater element is in a hole adjacent to the surface of said end plate which is contiguous with a fuel cell.

6. A method of operating a fuel cell power plant having at least one end plate, and fuel cells adjacent or near said end plate, said method comprising:
providing heat either from (a) electric resistance or (b) combustion of hydrocarbon fuel, (c) within a fuel cell which is contiguous with an end plate, (d) between an end plate and a fuel cell closest to an end plate, (e) within an end plate, or (f) on a surface of an end plate; and
operating said fuel cell power plant to produce electricity.

7. A method according to claim 6 wherein:
said step of providing provides heat within a portion of said end plate near a surface of said end plate which is contiguous with a fuel cell.

8. A method according to claim 6 wherein:
said step of providing is performed either before or during start-up of the fuel cell system, or both.
